(19) United States
(12) Patent Application Publication
(10) Pub. No.: US 2026/0134447 A1
(43) Pub. Date: May 14, 2026

(54) Good Customer Score (GCS)

(71) Applicant: Rex Pruitt, Conover, NC (US)

(72) Inventor: Rex Pruitt, Conover, NC (US)

(21) Appl. No.: 18/946,126

(22) Filed: Nov. 13, 2024

(51) Int. Cl. G06Q 30/0204

(52) U.S. Cl. CPC G06Q 30/0204

(57) ABSTRACT

The “Good Customer Score (GCS)” consists of the components necessary using data and analytics to effectively identify a “Good Customer.” GCS is to be used in predictive modeling projects designed to help improve the cost effectiveness and the new development of Acquisition, Retention, Recovery, Cross-sell, Reward, and Loss Prevention efforts. Adding the GCS to the Enterprise Data Warehouse would allow the enterprise to begin using GCS to develop specific targeted customer strategies.

### CROSS-REFERENCE TO RELATED APPLICATIONS

Application No. 63/654,953

Confirmation #1822

Filing or 371 (c) date Jun. 1, 2024

Status-Application Dispatched from Pre-exam, Not Yet Docketed Jun. 12, 2024Application type Provisional

Entity status Small

Correspondence address

200157-Rex Pruitt, 4162 Holly Cir NE, Conover, NC 28613, UNITED STATES

### BACKGROUND OF THE INVENTION

Using Predictive Analytics to identify a “Good Customer.”

Development of a “Good Customer Score (GCS)” solves specific business needs leveraging Internal Enterprise data.

To the CFO, a Good Customer is a one that generates high revenues with low expenses.

To the Operations Executives, a Good Customer is one that has good behavior & loyalty.

GCS Combines both perspectives maximizing the enterprise benefit leveraging a targeted data and analytics treatment to deliver “VALUE.”

### SUMMARY OF THE INVENTION

“Good Customer Score (GCS)” Development is determined by identifying what data attributes describe a “Good Customer.”

Developing the GCS requires acquiring the appropriate data, cleansing the data, adjusting the data for outliers, and applying relevant business rules.

The development effort begins with simple questions focused on identifying the unique enterprise customer data attributes.

The applied logical data and analytics programming result is adjusted as necessary with a weighting process to generate a ratio returned as a Good Customer Ratio (GCR)” subsequently converted to GCS.

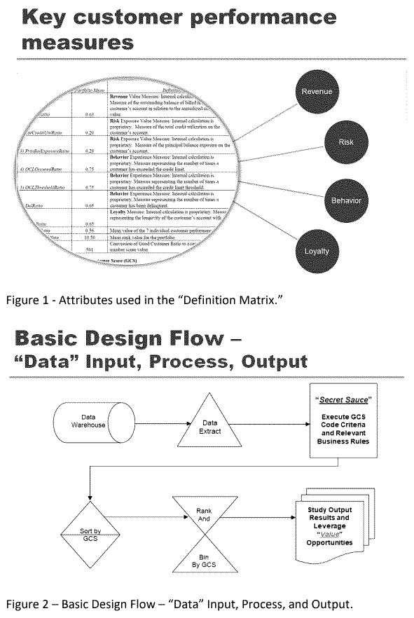

The GCS is ranked and binned to place customers within the categories of a “Definition Matrix” (see FIG. 1) to meet various relevant “Portfolio Scoring Objectives (PSOs).”

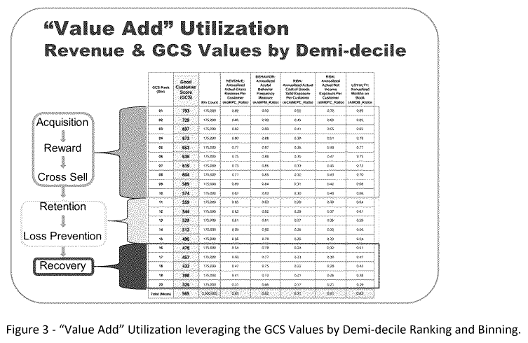

Examples of the PSO might be to identify best to worst customers or to clarify “target” segments and operational treatments (I.e., Acquisition, Rewards, Retention, and Recovery-see FIG. 3).

### BRIEF DESCRIPTION OF DRAWINGS

The included drawings are to provide a visualization of: FIG. 1—Attributes used in the “Definition Matrix.”; FIG. 2—Basic Design Flow—“Data” Input, Process, and Output; FIG. 3 “Value Add” Utilization leveraging the GCS Values by Demi-decile Ranking and Binning.

### DETAILED DESCRIPTION OF THE INVENTION

Good Customer Score (GCS) will be used in modeling exercises designed to help improve the cost effectiveness and development of Acquisition, Rewards, Retention, and Recovery efforts (see FIG. 1-3).

Adding the GCS to the relevant operational data and using it to develop and implement specific targeted Retention and other strategies will result is significant financial benefits. This is done using a confidential programmatic methodology and appending the resulting GCS to operational customer records for appropriate Acquisition, Rewards, Retention, and Recovery programs.

GCS inspired programs through the Data Analytics and predictive modeling process is very powerful and capable of generating significant lifts in revenue for any organization. Using Data Analytics tools in customer Acquisition, Rewards, Retention, and Recovery efforts will have a significant impact on a Company's business. Venturing into the huge amounts of internal customer data and information can be a daunting task. However, by employing predictive modeling, coupled with Data Analytics techniques, specifically GCS, significant value can be identified and leveraged.

During the GCS Development for use, a Data Analytics program is written that applies logic against internal customer data that has been cleansed and adjusted for outliers. Key customer performance measures are used in a weighting process to generate a ratio representative of a “Good Customer” based on an individual company's definition. The attributes leveraged are noted in the “Definition Matrix” (see FIG. 1).

Portfolio Scoring & Ranking of the “Good Customer Score” is then used to rank the portfolio of customers and bin them into 20 different buckets. Doing so isolates the customer profile characteristics that define the best vs. worst customers. This sets the stage for model and program development. It becomes clear how to “target” the specific segments for respective treatment depending on the customer's needs (e.g., acquire more good customer “look-a likes,” retain and/or reward the best performers, or take corrective action on poor performers). Data Analytics programing logic is designed specific to the individual Company's specifications to apply the detailed components of GCS of which I cannot share the actual data programming, variables, or formulas used in full context to generate the GCS. However, I can provide the basic logical flow (see FIG. 2).

### INVENTION SUMMARY

By using predictive modeling coupled with Data Analytics programming for Customer Intelligence portfolio segmentation, I have been able to generate huge lifts in revenue opportunity for the organization. My experience, as demonstrated by the examples illustrated in the context of this paper, is a clear depiction of the benefits resulting from the use of Data Analytics tools in business intelligence, specifically “Customer Intelligence.” Venturing into the huge amounts of internal customer data and information, or any other huge set of data, can be a daunting task. However, by employing predictive modeling, coupled with some Data Analytics techniques, gold nuggets can be identified.

SAS and all other SAS Institute Inc. product or service names are registered trademarks or trademarks of SAS Institute Inc. in the USA and other countries.® indicates USA registration.

Other brand and product names are trademarks of their respective companies.

1. A computer-implemented method for generating a customer profitability score, the method comprising:
receiving, by one or more processors, enterprise customer data comprising measurable input variables associated with revenue, risk, behavior, and loyalty categories;
normalizing, by a data-processing engine, the measurable input variables into a set of ratio values corresponding to the revenue, risk, behavior, and loyalty categories;
receiving, via a configuration interface, a selection of category-specific factors and associated weighting parameters defined by a financial decision-maker of an enterprise;
computing, by a scoring engine, a deterministic composite customer profitability ratio by applying the weighting parameters to the normalized ratio values and aggregating the weighted values;
transforming the composite customer profitability ratio into a whole-number customer profitability score by scaling the composite ratio to a predetermined numeric range;
ranking a plurality of customers based on their respective customer profitability scores; and
assigning each customer to a score segment or bin based on the ranking.

2. A computer system for generating a customer profitability score, the system comprising:
a data ingestion module configured to retrieve enterprise customer data comprising measurable input variables associated with revenue, risk, behavior, and loyalty categories;
a normalization module configured to convert the measurable input variables into normalized ratio values;
a configuration interface configured to receive factor selections and weighting parameters defined by a financial decision-maker of an enterprise;
a scoring engine configured to apply the weighting parameters to the normalized ratio values, compute a deterministic composite customer profitability ratio, and transform the composite ratio into a whole-number customer profitability score;
a ranking module configured to order customers based on their customer profitability scores; and
a segmentation module configured to assign customers to score segments or bins based on the ranking.

3. A non-transitory computer-readable medium storing instructions that, when executed by one or more processors, cause the processors to perform operations comprising:
receiving enterprise customer data comprising measurable input variables associated with revenue, risk, behavior, and loyalty categories;
normalizing the measurable input variables into ratio values;
receiving factor selections and weighting parameters defined by a financial decision-maker;
computing a deterministic composite customer profitability ratio based on the weighting parameters and the normalized ratio values;
transforming the composite ratio into a whole-number customer profitability score;
ranking customers based on the customer profitability score; and
assigning customers to score segments or bins based on the ranking.
